(19) United States
(12) Patent Application Publication
(10) Pub. No.: US 2024/0354747 A1
(43) Pub. Date: Oct. 24, 2024

(54) SYSTEMS AND METHODS FOR CRYPTOCURRENCY PAYMENTS

(71) Applicant: VeriFone, Inc., Wilmington, DE (US)

(72) Inventors: Jeremy Belostock, Burlingame, CA (US); James Harrison Bullard, Tampa, FL (US)

(73) Assignee: VeriFone, Inc., Wilmington, DE (US)

(21) Appl. No.: 18/557,778

(22) PCT Filed: Apr. 28, 2022
(86) PCT No.: PCT/US2022/071969

§ 371 Date: Oct. 27, 2023

Related U.S. Application Data
(60) Provisional application No. 63/180,918, filed on Apr. 28, 2021.

(51) Int. Cl. G06Q 20/36; G06Q 20/06; G06Q 20/20

(52) U.S. Cl. CPC G06Q 20/3678; G06Q 20/065; G06Q 20/204

(57) ABSTRACT

Systems, devices, and methods for facilitating a cryptocurrency transaction using a payment terminal operated by a merchant and an electronic device operated by a customer are provided. A customer may use a combination of the payment terminal and/or electronic device to select a cryptocurrency payment wallet to conduct the transaction and a type of cryptocurrency to pay for the transaction. Transaction information is provided to the electronic device via a machine-readable code displayed by the payment terminal and captured by a camera of the electronic device. The electronic device provides the transaction information to a cryptocurrency payment provider corresponding to the selected type of cryptocurrency. Upon completion of the transaction, the cryptocurrency payment provider provides a payment confirmation to the payment terminal and/or the electronic device.

### CROSS-REFERENCE TO RELATED APPLICATIONS

This application claims priority to U.S. Provisional Patent Application Ser. No. 63/180,918 filed Apr. 28, 2021, and entitled “Systems and Methods Cryptocurrency Payments,” the entire disclosure of which is incorporated herein by reference.

### FIELD OF THE DISCLOSURE

The present disclosure is directed generally to systems, devices, and methods for facilitating cryptocurrency payments.

### BACKGROUND

As cryptocurrency becomes more widely accepted, there is a need in the art for systems and methods for facilitating in-person cryptocurrency payments.

### SUMMARY OF THE DISCLOSURE

The present disclosure provides systems, devices, and methods for facilitating a cryptocurrency transaction using a payment terminal configured by a merchant and an electronic device operated by a customer. In this disclosure, the customer may use the payment terminal and/or electronic device to select (1) a cryptocurrency payment wallet to conduct the transaction and (2) a type of cryptocurrency to pay for the transaction. Transaction information is provided to the electronic device via a machine-readable code displayed by the payment terminal.

In one example, a customer conducting a transaction interacts with a payment terminal. The payment terminal includes a display which shows cryptocurrency payment wallet icons indicating the types of payment wallets (Coinbase®, BitPay®, etc.) accepted by the merchant. The display may also show cryptocurrency icons indicating the types of cryptocurrency (such as Bitcoin®, Bitcoin Cash®, Ethereum®, Dogecoin™, XRP™, etc.) accepted by the merchant.

The payment terminal then generates a machine-readable code containing transaction information. The machine-readable code can be a quick response (QR) or bar code encoded with the transaction information. The transaction information can include a wide variety of data related to the present transaction including a payment total (such as a figure in US dollars), a merchant identifier (such as the name or location of a store), a payment terminal identifier (such as an alphanumeric code corresponding to the payment terminal), product information (such as the names of the products being purchased and their associated prices and/or quantities), and/or service information (such as the names of the services being purchased and their associated prices and/or quantities).

In some examples, the machine-readable code may correspond to a selected cryptocurrency payment wallet. In these examples, the customer chooses the cryptocurrency payment wallet by entering an input into the payment terminal. In one example, the display of the payment terminal is a touchscreen, and the customer selects a cryptocurrency payment wallet by touching a corresponding cryptocurrency payment wallet icon. In another example, the customer selects the cryptocurrency payment wallet via a keypad of the payment terminal.

The payment terminal shows the machine-readable code on the display. The customer then uses an electronic device (such as a smartphone, tablet computer, or other mobile device) to capture the machine-readable code. The electronic device may capture the machine-readable code using a camera. The payment terminal may also display additional information regarding the transaction, such as a payment total shown in government-issued currency (such as US Dollars, European Euros, British Pounds, Japanese Yen, etc.) or cryptocurrency (such as Bitcoin®, Bitcoin Cash®, Ethereum®, etc.). If the machine-readable code corresponds to a selected cryptocurrency payment wallet, a corresponding cryptocurrency icon may also be displayed.

Capturing the machine-readable code triggers the electronic device to launch a cryptocurrency payment wallet. If the machine-readable code includes information indicating the selection of a particular cryptocurrency payment wallet, the selected cryptocurrency payment wallet will be launched. If not, the customer may the select then desired cryptocurrency payment wallet on the electronic device. Alternatively, a default cryptocurrency payment wallet may be launched.

Once the cryptocurrency payment wallet is launched on the electronic device, the customer may choose which cryptocurrency (or combination of cryptocurrency) to use for the transaction. To facilitate the selection, the electronic device displays one or more cryptocurrency icons indicating available types of cryptocurrency for this transaction. The available types of cryptocurrency may be limited by cryptocurrency payment wallet and/or the merchant. The customer may then touch the display of the electronic device to select one of the available cryptocurrencies.

Upon receiving the selection of the cryptocurrency, the electronic device conveys the transaction information to a cryptocurrency payment provider for the selected cryptocurrency. The cryptocurrency payment provider executes the payment, and provides the payment terminal with a payment confirmation. The display of the payment terminal then shows the payment confirmation, and the transaction is complete.

Generally, in one aspect, a method for cryptocurrency payments is provided. The method includes displaying, by a display on a payment terminal, one or more cryptocurrency payment wallet icons.

The method further includes receiving, by the payment terminal, a selection of a cryptocurrency payment wallet for conducting a transaction. The selection corresponds to one of the one or more cryptocurrency payment wallet icons. According to an example, the display on the payment terminal is a touchscreen, and the selection of the cryptocurrency payment wallet is received via the touchscreen. In another example, the selection of the cryptocurrency payment wallet is received via a keypad on the payment terminal.

The method further includes generating, by the payment terminal, a machine-readable code for the selection of the cryptocurrency payment wallet. The selection of the cryptocurrency payment wallet may correspond to one of the one or more cryptocurrency payment wallet icons. The machine-readable code includes transaction information. The machine-readable code may be a QR code. The transaction information may include a payment total, a merchant identifier, a payment terminal identifier, product information, and/or service information. The machine-readable code may be displayed with the payment total.

The method further includes displaying, by the display on the payment terminal, the machine-readable code.

The method further includes receiving, by the payment terminal, a payment confirmation from a cryptocurrency payment provider selected from the cryptocurrency payment wallet.

The method further includes displaying, by the display on the payment terminal, the payment confirmation. The payment confirmation may be displayed as a government-issued currency payment total and/or a cryptocurrency payment total.

According to an example, the payment terminal is configured to display one or more cryptocurrency icons. In this example, the cryptocurrency payment provider corresponds to one of the one or more cryptocurrency icons.

Generally, in another aspect, a method for cryptocurrency payments is provided. The method includes capturing, by an electronic device, a machine-readable code. The machine-readable code comprises transaction information for a transaction conducted at a payment terminal. According to an example, the transaction information comprises a payment total, a merchant identifier, a payment terminal identifier, product information, and/or service information.

The method further includes executing, by the electronic device, a cryptocurrency payment wallet upon capturing the machine-readable code. According to an example, the cryptocurrency payment wallet is executed based on the machine-readable code. Alternatively, the cryptocurrency payment wallet may be executed based on a default wallet setting stored on the electronic device. The machine-readable code may be a QR code. According to an example, the machine-readable code is captured by a camera of the electronic device.

The method further includes rendering, on a display of the electronic device, one or more cryptocurrency icons.

The method further includes receiving, by the cryptocurrency payment wallet on the electronic device, a selection of a cryptocurrency for the transaction. The selection corresponds to one of the one or more cryptocurrency icons. The selection of the cryptocurrency may be received via a touchscreen on the electronic device.

The method further includes communicating, by the cryptocurrency payment wallet on the electronic device, the transaction information to a cryptocurrency payment provider for the selected cryptocurrency. The cryptocurrency payment provider corresponds to the one of the one or more cryptocurrency icons.

According to an example, the method further includes rendering, on the display of the electronic device, one or more cryptocurrency payment wallet icons. The cryptocurrency payment wallet is executed based on a wallet selection input received by the electronic device. The wallet selection input corresponds to the selected cryptocurrency of the one of the one or more cryptocurrency payment wallet icons.

According to an example, the method further includes displaying, by the electronic device, the transaction information.

According to an example, the method further includes receiving, by the electronic device, a payment confirmation from the cryptocurrency payment provider. The method further includes displaying, by the electronic device, the payment confirmation. The payment confirmation may be displayed by the cryptocurrency payment wallet on the electronic device.

Generally, in another aspect, a method for cryptocurrency payments is provided. The method includes capturing, by an electronic device, a machine-readable code. The machine-readable code includes transaction information for a transaction conducted at a payment terminal. The machine-readable code indicates a cryptocurrency for the transaction.

The method further includes determining, by the electronic device, one or more cryptocurrency payment wallets capable of handling the cryptocurrency indicated by the machine-readable code.

The method further includes rendering, on a display of the electronic device, one or more cryptocurrency payment wallet icons corresponding to the one or more cryptocurrency payment wallets.

The method further includes receiving, by the electronic device, a selection of one of the one or more cryptocurrency payment wallets.

The method further includes executing, by the electronic device, a cryptocurrency payment wallet based on the selection of the one of the one or more cryptocurrency payment wallet.

The method further includes communicating, by the executed cryptocurrency payment wallet on the electronic device, the transaction information to a cryptocurrency payment provider associated with the cryptocurrency indicated by the machine-readable code.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a diagram of an example system for processing cryptocurrency payments, according to aspects of the present disclosure.

FIG. 2 is an illustration of an example payment terminal and an example electronic device processing a cryptocurrency payment, according to aspects of the present disclosure.

FIG. 3 is a further illustration of an example payment terminal and an example electronic device processing a cryptocurrency payment, according to aspects of the present disclosure.

FIG. 4 is a further illustration of an example payment terminal and an example electronic device processing a cryptocurrency payment, according to aspects of the present disclosure.

FIG. 5 is a further illustration of an example payment terminal and an example electronic device processing a cryptocurrency payment, according to aspects of the present disclosure.

FIG. 6 is a further illustration of an example payment terminal and an example electronic device processing a cryptocurrency payment, according to aspects of the present disclosure.

FIG. 7 is a further illustration of an example payment terminal and an example electronic device processing a cryptocurrency payment, according to aspects of the present disclosure.

FIG. 8 is a further illustration of an example payment terminal and an example electronic device processing a cryptocurrency payment, according to aspects of the present disclosure.

FIG. 9 is a schematic representation of an example payment terminal for processing a cryptocurrency payment, according to aspects of the present disclosure.

FIG. 10 is a schematic representation of an example electronic device for processing a cryptocurrency payment, according to aspects of the present disclosure.

FIG. 11 is a schematic illustration of a payment terminal, according to aspects of the present disclosure.

FIG. 12 is a schematic illustration of an electronic device, according to aspects of the present disclosure.

FIG. 13 is a flowchart of an example method for processing a cryptocurrency payment, according to aspects of the present disclosure.

FIG. 14 is a flowchart of a further example method for processing a cryptocurrency payment, according to aspects of the present disclosure.

FIG. 15 is a flowchart of a further example method for processing a cryptocurrency payment, according to aspects of the present disclosure.

### DETAILED DESCRIPTION OF EMBODIMENTS

The present disclosure provides systems, devices, and methods for facilitating a cryptocurrency transaction using a payment terminal operated by a merchant and an electronic device operated by a customer. In this disclosure, the customer may use the payment terminal and/or electronic device to select (1) a cryptocurrency payment wallet to conduct the transaction and (2) a type of cryptocurrency to pay for the transaction. Transaction information is provided to the electronic device via a machine-readable code displayed by the payment terminal and captured by a camera of the electronic device. The electronic device provides the transaction information to a cryptocurrency payment provider corresponding to the selected type of cryptocurrency. The cryptocurrency payment provider then provides a payment confirmation to the payment terminal and/or the electronic device.

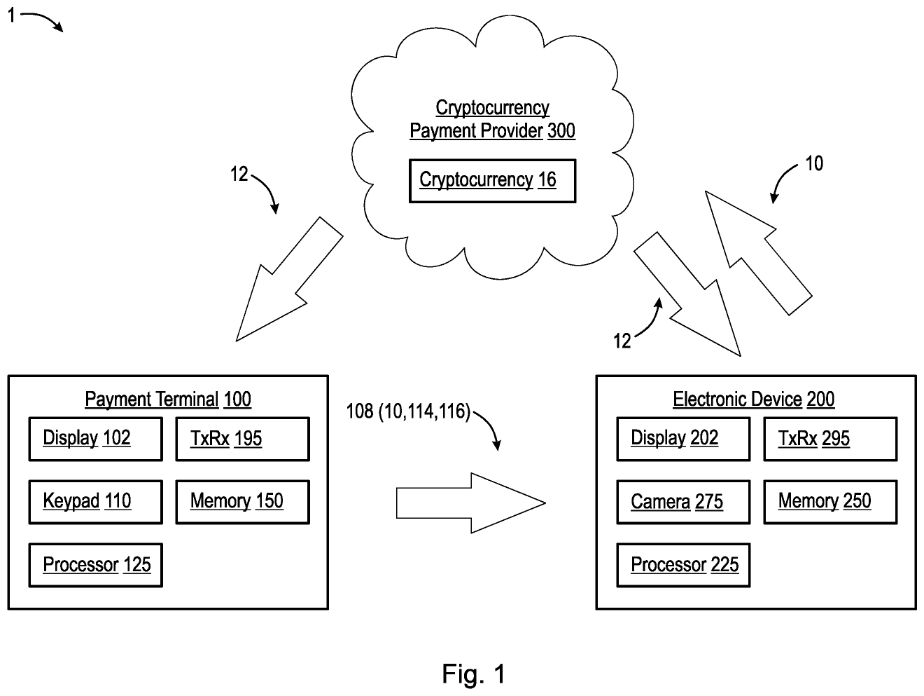

FIG. 1 is a diagram of an example system 1 for processing cryptocurrency payments. Broadly, the system 1 includes a payment terminal 100, an electronic device 200, and a cryptocurrency payment provider 300 corresponding to a type of cryptocurrency 16.

Generally, the payment terminal 100 is a device to facilitate payment from a customer to a merchant for a good or service. The payment terminal 100 will typically include a display 102 (such as a touchscreen), a keypad 110, a processor 125, a memory 150, and a transceiver 195. The payment terminal 100 receives transaction information 10 from the merchant regarding goods or services to be purchased by the customer. The transaction information 10 may include a wide array of information, such as a payment total (such as a figure in US dollars), a merchant identifier (such as the name or location of the merchant), a payment terminal identifier (such as an alphanumeric code corresponding to the payment terminal), product information (such as the names or product numbers of the products being purchased and their associated prices and/or quantities), and/or service information (such as the names of the services being purchased and their associated prices and/or quantities). Other information may be included in the transaction information 10. The payment total may be provided in a variety of formats, such as government-issued currency (such as US Dollars, European Euros, British Pounds, Japanese Yen, etc.) or cryptocurrency (such as Bitcoin®, Bitcoin Cash®, Ethereum®, etc.).

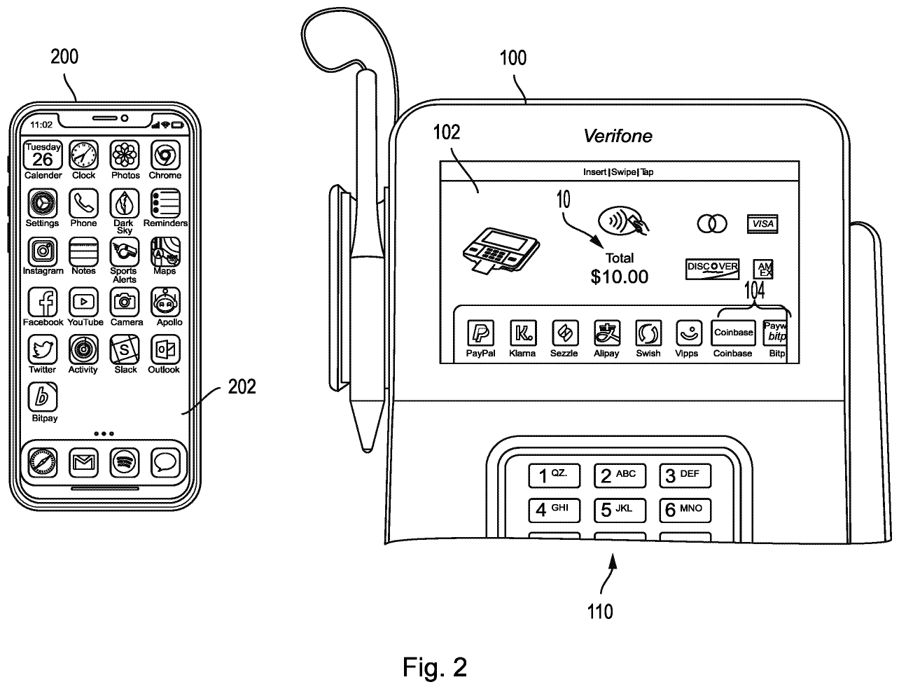

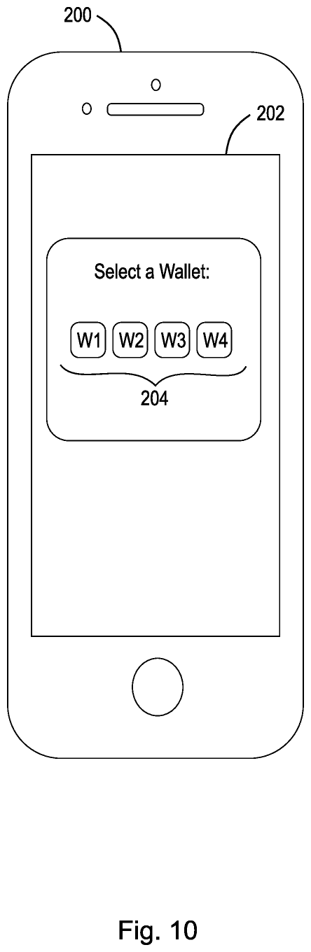

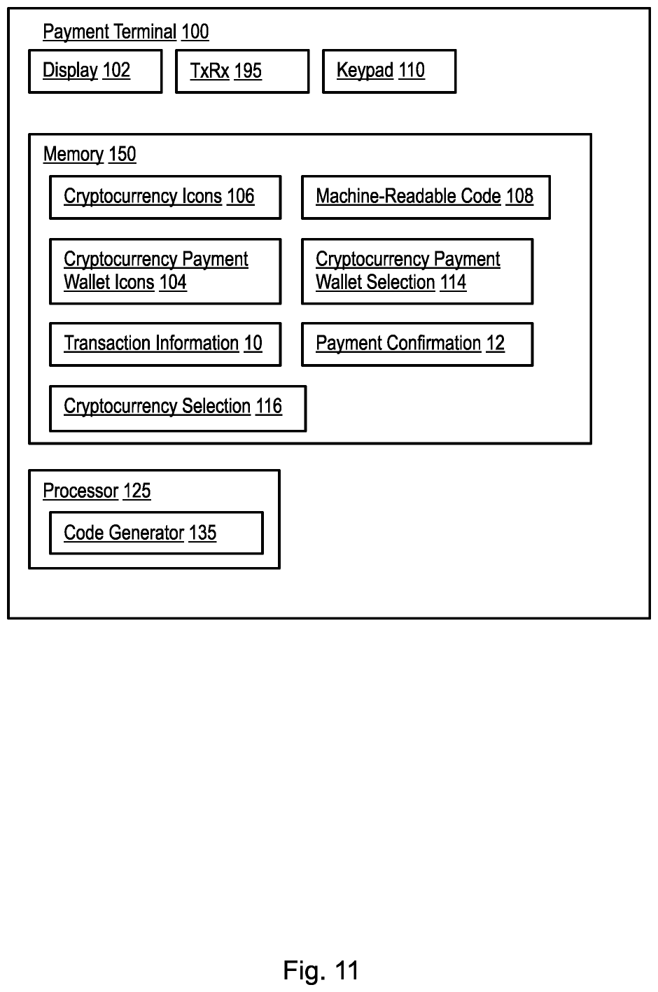

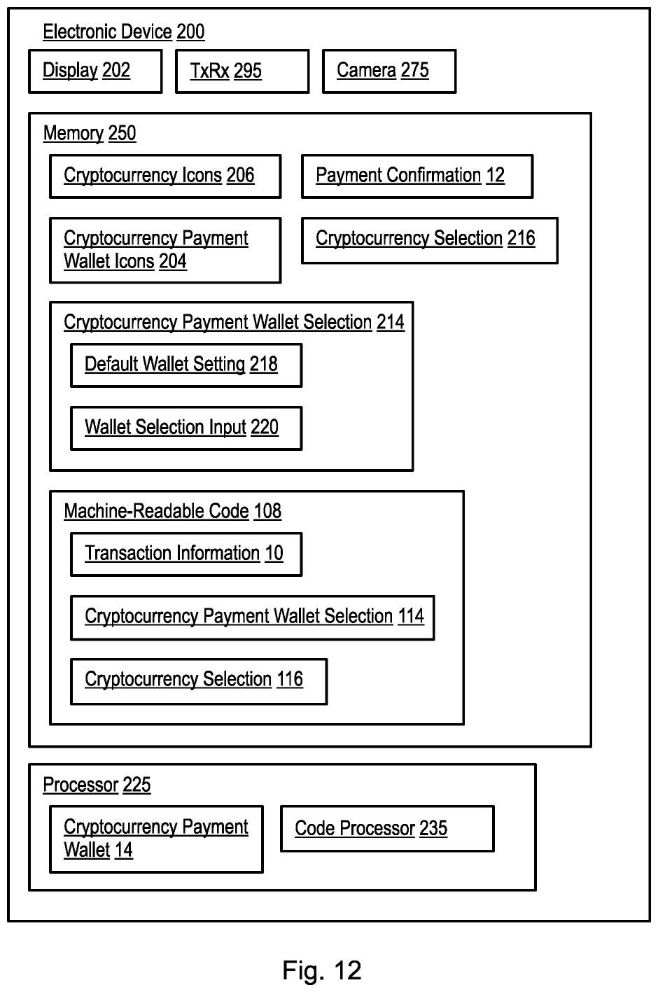

The processor 125 of the payment terminal 100 encodes the transaction information 10 into a machine-readable code 108, such as a quick-response (QR) code or a bar code. The machine-readable code 108 may indicate additional information, such as a selected cryptocurrency payment wallet 14 (see FIG. 12) or a selected type of cryptocurrency 16 as chosen by the customer on the payment terminal 100 or by the merchant. For instance, the customer may indicate a cryptocurrency payment wallet selection 114 (see FIG. 11) by selecting a cryptocurrency payment wallet icon 104 (see FIG. 2) shown on the display 102. Similarly, the customer may indicate a cryptocurrency selection 116 (see FIG. 11) by selecting a cryptocurrency icon 106 (see FIG. 10) shown on the display 102. In the example of the display 102 as a touchscreen, the cryptocurrency payment wallet selection 114 and/or cryptocurrency selection 116 may be received by touching the display 102. In other examples, the selection of the cryptocurrency payment wallet selection 114 and/or cryptocurrency selection 116 may be received by actuating one or more keys of the keypad 110. Other means for receiving the cryptocurrency payment wallet selection 114 and/or cryptocurrency selection 116 may be available depending on the application. In further examples, the selection of the type of cryptocurrency payment wallet 14, 114 and/or the type of cryptocurrency 16, 116 may be made using the electronic device 200. One or more icons can be displayed for selection, and the icons may correspond to the types of cryptocurrency payment wallets 14 and cryptocurrencies 16 accepted by the merchant. For example, if the merchant only accepts Bitcoin® or Ethereum® cryptocurrency via Coinbase® or BitPay® wallets, the cryptocurrency payment wallet icons 114 will include only Bitcoin® and Ethereum® icons, and the cryptocurrency icons 116 will include only Coinbase® and BitPay® icons.

Once the processor 125 has generated the machine-readable code 108, the code 108 is shown on the display 102 of the payment terminal 100. The machine-readable code 108 may be displayed with aspects of the transaction information 10, such as the payment total. Once shown, the machine-readable code 108 is captured or read by an electronic device 100 operated by the customer. Generally, the electronic device 200 includes a display 202, a processor 225, a memory 250, a camera 275, and a transceiver 295. The display 202 may be a touchscreen. In some cases, the electronic device 200 may be a portable communication device, such as a smartphone or tablet computer. Other types of electronic devices 200 may be used depending on the application. In some examples, the electronic device 200 captures the machine-readable code 108 using the camera 275. Other means for capturing the machine-readable code 108 may be used depending on the application.

The processor 225 of the electronic device 200 then processes the captured machine-readable code 108 to extract the transaction information 10, as well as to determine if the code 108 indicates a cryptocurrency payment wallet selection 114 and/or cryptocurrency selection 116. If the code 108 indicates a cryptocurrency payment wallet selection 114 made on the payment terminal 100, the processor 225 launches the appropriate cryptocurrency payment wallet 14 (for example, Coinbase®). If not, the processor 225 may launch a default cryptocurrency payment wallet 14. Alternatively, the display 202 of the electronic device 200 may show a plurality of cryptocurrency payment wallet icons 204 (see FIG. 10) corresponding to the cryptocurrency payment wallets 14 which may be launched by the processor 225 of the electronic device 200. The customer can then select one of the cryptocurrency payment wallets via a wallet selection input 220 (see FIG. 12), such as touching a desired cryptocurrency payment wallet icon 204 on the touchscreen of the display 202 with their fingertip. Similarly, the display 202 may show a default cryptocurrency payment wallet icon 204 and a plurality of other (i.e., non-default) cryptocurrency payment wallet icons 204 corresponding to the default and non-default cryptocurrency payment wallets 14 which may be launched by the processor 225 of the electronic device 200. In an embodiment, the customer can opt to proceed with the default cryptocurrency payment wallet that can be pre-selected or select one of the non-default cryptocurrency payment wallets 14 instead.

Once launched, the selected cryptocurrency payment wallet 14 may provide the customer with a variety of transaction information 10, such as a payment total in government-issued currency. If the machine-readable code 108 indicates a cryptocurrency selection 116 made on the payment terminal or by the merchant, the cryptocurrency payment wallet 14 may display the selected type of cryptocurrency 16 (Bitcoin®, Ethereum®, etc.).

If the machine-readable code 108 does not indicate a cryptocurrency selection 116 made via the payment terminal 100 or by the merchant, the selected cryptocurrency payment wallet 14 can display one or more cryptocurrency icons 206 indicating the types of cryptocurrency 16 available to the customer to pay for the transaction using the selected cryptocurrency payment wallet 14. The cryptocurrency payment wallet 14 may also display cryptocurrency totals for each type of cryptocurrency 16 and/or a conversion to government-issued currency for the transaction information 10. The customer may then make a cryptocurrency selection 216 according to the displayed cryptocurrency icons 206. For example, the user may enter the cryptocurrency selection 216 by touching the desired type of cryptocurrency icon 206 on the touchscreen of the display 202 with their fingertip or a stylus.

Once the type of cryptocurrency 16 is selected, the electronic device 200 transmits the extracted transaction information 10 to a cryptocurrency payment provider 300 capable of executing a transaction for the selected type of cryptocurrency 16. The cryptocurrency payment provider 300 may be cloud-based. For instance, if Bitcoin® is the selected type of cryptocurrency 16, the transaction information 10 is transmitted to a cryptocurrency payment provider 300 capable of transferring a Bitcoin® amount equal to the payment total from the customer to the merchant. Once the transfer is completed, the cryptocurrency payment provider 300 transmits a payment confirmation 12 to the payment terminal 100 and/or the electronic device 200. The payment terminal 100 and/or the electronic device 200 then displays the payment confirmation 12, indicating to the customer that the transaction has been successfully completed. The payment confirmation 12 can also be displayed to the merchant.

FIG. 2 shows an example payment terminal 100 and an example electronic device 200. As shown in FIG. 2, the electronic device 200 is depicted as a smartphone. The display 202 of the electronic device 200 is a touchscreen. The payment terminal 100 includes a display 102, which may also be a touchscreen, and a keypad 110. The display 102 shows transaction information 10 in the form of a payment total ($10.00). The display 102 also shows a pair of cryptocurrency payment wallet icons 104 for two types of cryptocurrency payment wallets 14, Coinbase® and Bitpay®, accepted by the merchant.

From the payment terminal 100 of FIG. 2, a customer enters a cryptocurrency payment wallet selection 114 corresponding to Coinbase®. The cryptocurrency payment wallet selection 114 may be received by the payment terminal 100 by the customer touching the corresponding cryptocurrency payment wallet icon 104 with their fingertip or any suitable alternative. Alternatively, the customer may enter the cryptocurrency payment wallet selection 114 via keypad 110.

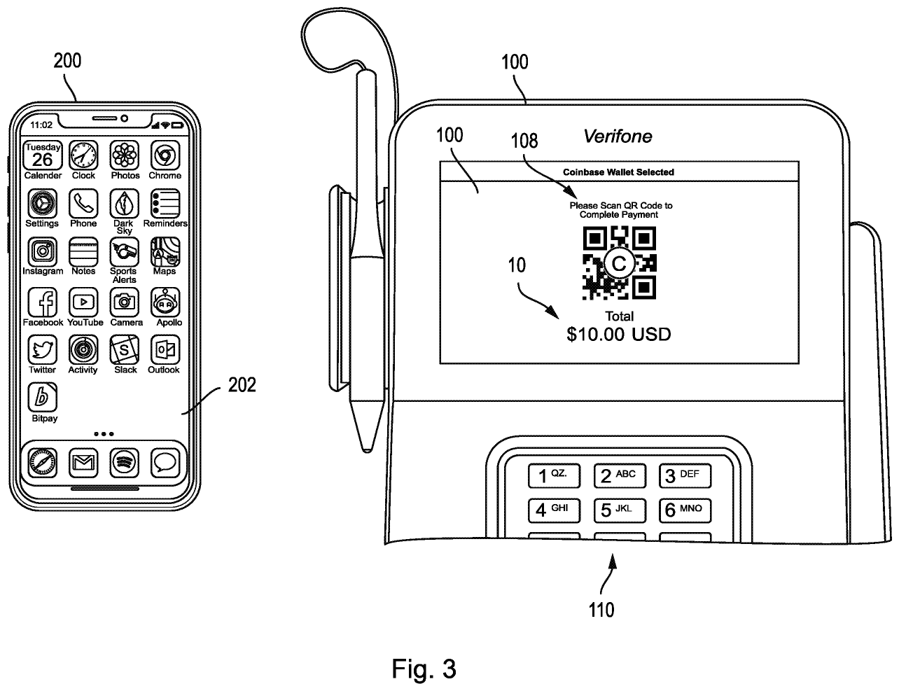

Having received a cryptocurrency payment wallet selection 114 for Coinbase®, the payment terminal 100 generates and displays a machine-readable code 108, as shown in FIG. 3. The machine-readable code 108 incorporates the transaction information 10 (such as payment total) and the cryptocurrency payment wallet selection 114. As shown in FIG. 3, a Coinbase® icon can be displayed over the machine-readable code 108 to indicate to the customer that capturing the code 108 will launch a Coinbase®-branded cryptocurrency payment wallet 14.

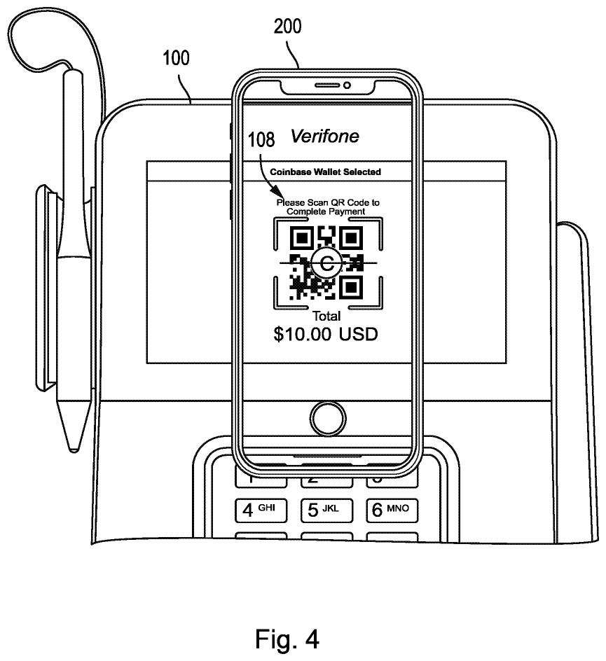

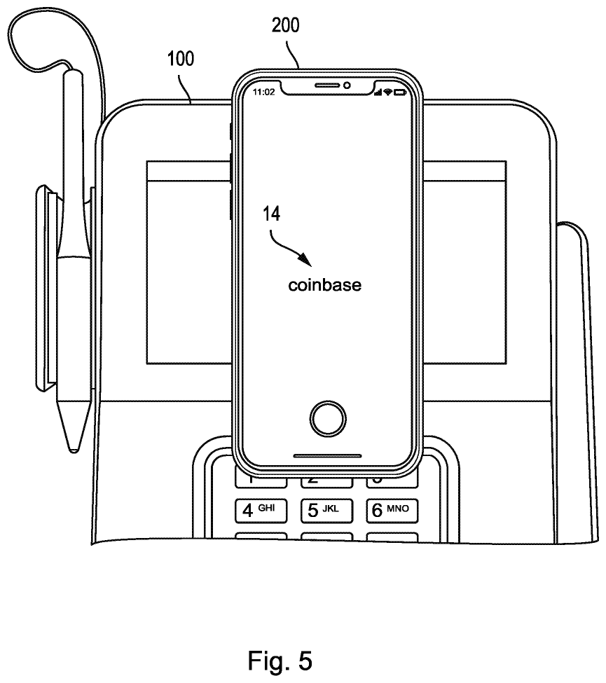

FIG. 4 illustrates the electronic device 200 capturing the machine-readable code 108. In this example, the electronic device 200 may capture the machine-readable code 108 using a camera 275. In an embodiment, as opposed to or in addition to the Coinbase® icon being displayed over the machine-readable code 108 on the payment terminal 100, the Coinbase® icon can be displayed on the electronic device 200 to indicate to the customer that the capturing of the code 108 will launch a Coinbase®-branded cryptocurrency payment wallet 14. Capturing and processing the machine-readable code 108 triggers the electronic device 200 to launch a cryptocurrency payment wallet 14, namely a Coinbase® wallet, as shown in FIG. 5.

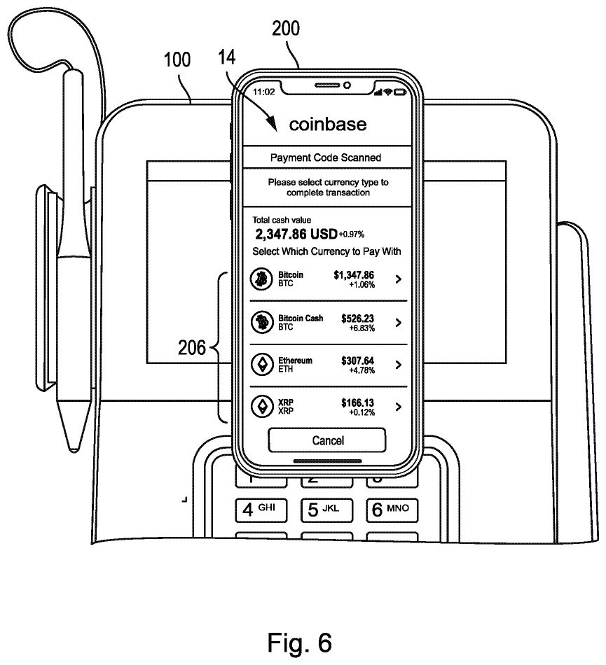

FIG. 6 shows the selected cryptocurrency payment wallet 14 on the display 202 of the electronic device 200. As shown, the cryptocurrency payment wallet 14 shows four cryptocurrency icons 206 corresponding to Bitcoin®, Bitcoin Cash®, Ethereum®, and XRP™. The cryptocurrency payment wallet 14 also shows the value of each type of cryptocurrency 16 available for the customer to use, as well as a percentage of recent fluctuations in value. The customer may then enter a cryptocurrency selection 216 by touching the corresponding cryptocurrency icon 206 (or the area proximate to the icon 206) with their fingertip or otherwise.

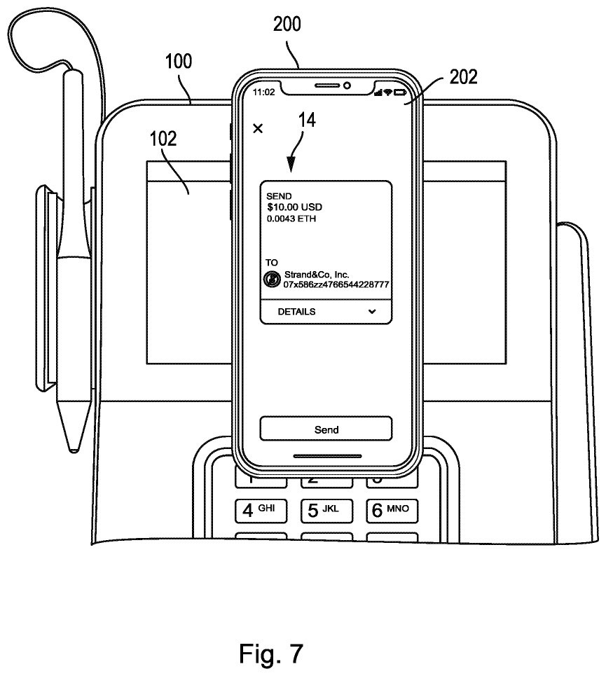

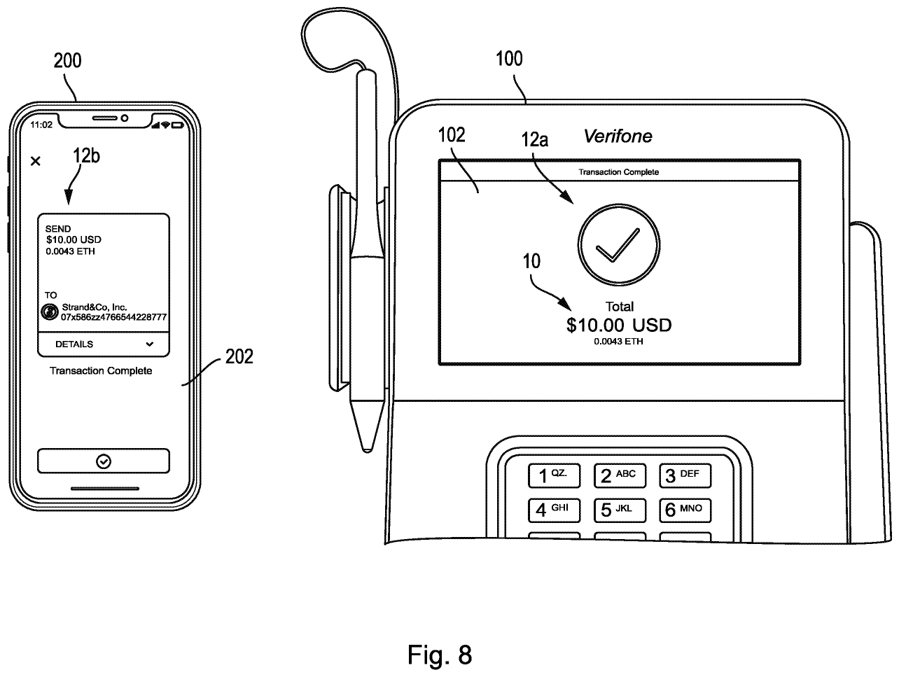

FIG. 7 shows the cryptocurrency payment wallet 14 as having received a cryptocurrency selection 216 of Ethereum®. The cryptocurrency payment wallet further displays transaction information 10 in the form of a payment total in multiple currencies ($10.00 USD and 0.0043 ETH) and a merchant identifier (Strand & Co., Inc.). The customer may then select “Send” to transmit the transaction information 10 to a cryptocurrency payment provider 300 capable of processing transactions of the selected cryptocurrency 16, in this case Ethereum®. Following processing the transaction, the cryptocurrency payment provider 300 transmits a first payment confirmation 12a to the payment terminal 100, and/or a second payment confirmation 12b to the electronic device 200. Either or both of the payment confirmations 12 can then be displayed on the payment terminal 100 and the electronic device 200, respectively. Aspects of the transaction information 10, as shown in FIG. 8, can also be displayed with either or both of the payment confirmations 12.

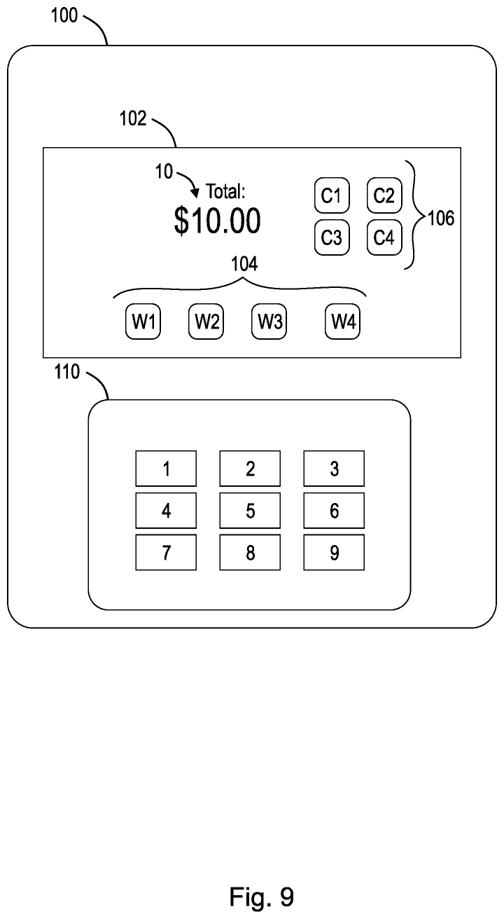

FIG. 9 shows a variation of the previously described embodiments in which the payment terminal 100 displays both cryptocurrency payment wallet icons 104 and type of cryptocurrency icons 106. Accordingly, in this example, the customer may enter both a cryptocurrency payment wallet selection 114 and a cryptocurrency selection 116 using the payment terminal 100. Further, the generated machine-readable code 108 can indicate the selections 114, 116. Upon capturing the machine-readable code 108, the electronic device 200 launches a cryptocurrency payment wallet 114 corresponding to the cryptocurrency payment wallet selection 114, configured to execute a transaction using a cryptocurrency 16 corresponding to the cryptocurrency selection 116 without requiring a further selection from the user on the electronic device 200.

FIG. 10 shows a further variation of the previously described embodiments, in which a customer has entered a cryptocurrency selection 116, but not a cryptocurrency payment wallet selection 114, via the payment terminal 100. The machine-readable code 108 indicates the cryptocurrency selection 116. Upon capturing the machine-readable code 108, the electronic device 200 presents the customer with four cryptocurrency payment wallet icons 204. The customer may then enter a cryptocurrency payment wallet selection 214 by touching one of the cryptocurrency payment wallet icons 204 with their fingertip or any suitable alternative. This cryptocurrency payment wallet selection 214 may trigger the electronic device 200 to launch a corresponding cryptocurrency payment wallet 14 configured to execute a payment according to the received cryptocurrency selection 116.

FIG. 11 shows a schematic illustration of an example payment terminal 100. The payment terminal 100 includes a display 102, a keypad 110, a processor 125, a memory 150, and a transceiver 195. The memory 150 stores transaction information 10 received from a merchant. The memory 150 also stores one or more cryptocurrency payment wallet icons 104 and one or more cryptocurrency icons 106 to be shown on the display 102. The memory may further store a cryptocurrency payment wallet selection 114 and/or a type of cryptocurrency selection 116 received from a combination of the display 102 and/or the keypad 110. The processor 125 uses a code generator 135 to create a machine-readable code 108 based on at least the transaction information 10, as well as, in some examples, the cryptocurrency payment wallet selection 114 and/or the cryptocurrency selection 116. The machine-readable code 108 may then be stored in memory 150 and retrieved to be shown on the display 102. Once the transaction is completed, the payment terminal 100 may receive a payment confirmation 12 from a cryptocurrency payment provider 300 via the transceiver 195. The payment confirmation 12 may be stored in memory 150 and shown on the display 102.

FIG. 12 shows a schematic illustration of an example electronic device 200. The electronic device 200 includes a display 202, a processor 225 comprising code processor 235, a memory 250, a camera 275, and a transceiver 295. The camera 275 captures a machine-readable code 108 displayed by the payment terminal 100. The processor 225 extracts transaction information 10 from the machine-readable code 108 using code processor 235. In some examples, the code processor 235 may also extract a cryptocurrency payment wallet selection 114 and/or a cryptocurrency selection 116 from the machine-readable code 108.

If a cryptocurrency payment wallet selection 114 has been extracted from the machine-readable code 108, the processor 225 launches a corresponding cryptocurrency payment wallet 14. If not, the cryptocurrency payment wallet 14 is selected based on a cryptocurrency payment wallet selection 214 retrieved by the electronic device 200. In one example, the cryptocurrency payment wallet 14 is launched based on a default wallet setting 218 stored in the memory 250. In another example, the display 202 shows one or more cryptocurrency payment wallet icons 204 stored in the memory 250 which can include an icon 204 corresponding to a default wallet. The electronic device 200 then receives a wallet selection input 220 corresponding to one of the cryptocurrency payment wallet icons 204. The processor 225 then launches the cryptocurrency payment wallet 14 corresponding to the wallet selection input 220.

Next, if a type of cryptocurrency selection 116 has been extracted from the machine-readable code 108, the cryptocurrency payment wallet 14 may execute the transaction by transmitting, via transceiver 295, the transaction information 10 to a cryptocurrency payment provider 300 corresponding to the selected type of cryptocurrency 16. If not, the cryptocurrency payment wallet 14 shows one or more cryptocurrency icons 206. The customer may then enter a cryptocurrency selection 216 corresponding to one of the cryptocurrency icons 206 via the display 202. Once the transaction is completed, the electronic device 200 may receive a payment confirmation 12 from the cryptocurrency payment provider 300 via the transceiver 295. The payment confirmation 12 may be stored in memory 250 and shown on the display 202.

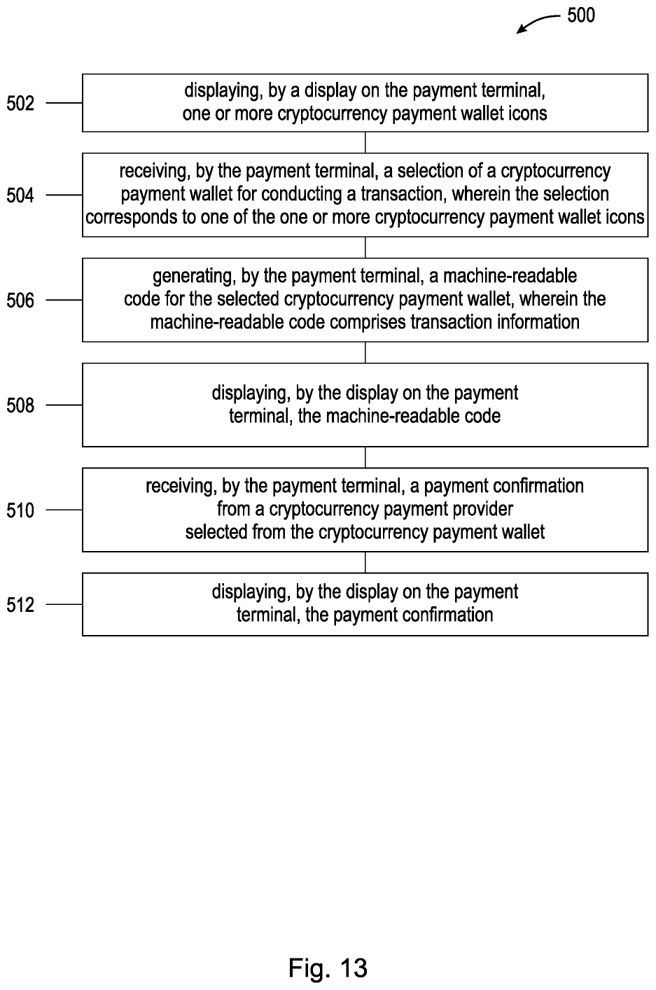

FIG. 13 is a flowchart of an example method 500 for processing cryptocurrency payments. The method 500 includes displaying 502, by a display on the payment terminal, one or more cryptocurrency payment wallet icons.

The method 500 further includes receiving 504, by the payment terminal, a selection of a cryptocurrency payment wallet for conducting a transaction. The selection corresponds to one of the one or more cryptocurrency payment wallet icons. According to an example, the display on the payment terminal is a touchscreen, and the selection of the cryptocurrency payment wallet is received via the touchscreen. In another example, the selection of the cryptocurrency payment wallet is received via a keypad on the payment terminal. The selected cryptocurrency payment wallet may correspond to one of the one or more cryptocurrency payment wallet icons.

The method 500 further includes generating 506, by the payment terminal, a machine-readable code for the selection of the cryptocurrency payment wallet. The machine-readable code includes transaction information. The machine-readable code may be a QR code. The transaction information may include a payment total, a merchant identifier, a payment terminal identifier, product information, and/or service information. The machine-readable code may be displayed with the payment total.

The method 500 further includes displaying 508, by the display on the payment terminal, the machine-readable code.

The method 500 further includes receiving 510, by the payment terminal, a payment confirmation from a cryptocurrency payment provider associated with a cryptocurrency selected from the cryptocurrency payment wallet.

The method 500 further includes displaying 512, by the display on the payment terminal, the payment confirmation. The payment confirmation may be displayed with a government-issued currency payment total and/or a cryptocurrency payment total.

According to an example, the payment terminal is configured to display one or more cryptocurrency icons. In this example, the cryptocurrency payment provider corresponds to one of the one or more cryptocurrency icons.

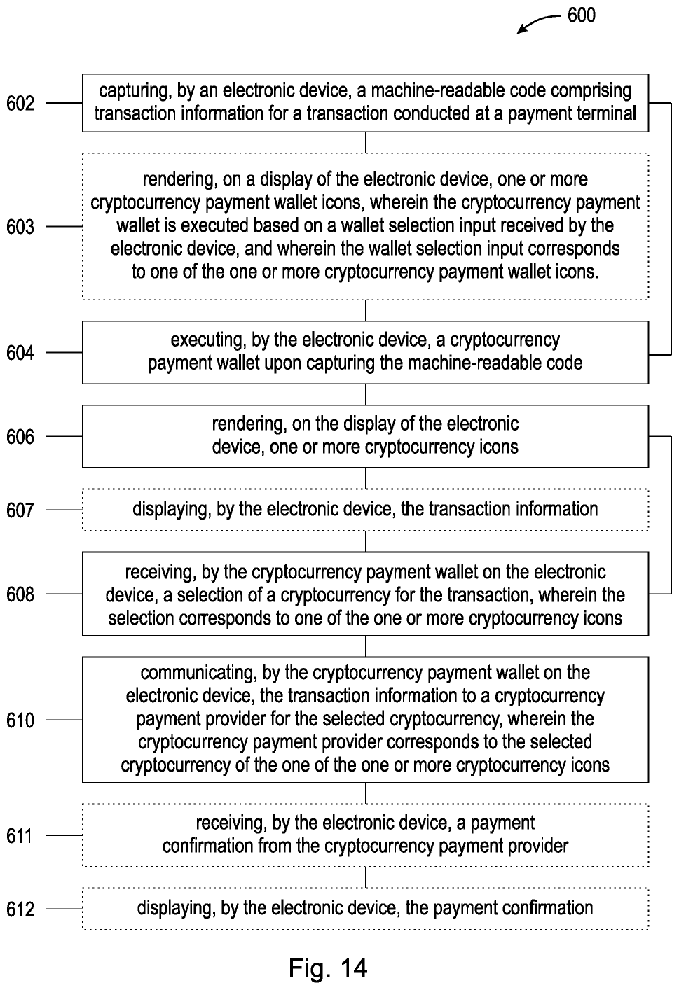

FIG. 14 is a flowchart of a further example method 600 for processing cryptocurrency payments. The method 600 includes capturing 602, by an electronic device, a machine-readable code. The machine-readable code comprises transaction information for a transaction conducted at a payment terminal. According to an example, the transaction information comprises a payment total, a merchant identifier, a payment terminal identifier, product information, and/or service information.

The method 600 further includes executing 604, by the electronic device, a cryptocurrency payment wallet upon capturing the machine-readable code. According to an example, the cryptocurrency payment wallet is executed based on the machine-readable code. Alternatively, the cryptocurrency payment wallet may be executed based on a default wallet setting stored on the electronic device. The machine-readable code may be a QR code. According to an example, the machine-readable code is captured by a camera of the electronic device.

The method 600 further includes rendering 606, on a display of the electronic device, one or more cryptocurrency icons.

The method 600 further includes receiving 608, by the cryptocurrency payment wallet on the electronic device, a selection of a cryptocurrency for the transaction. The selection corresponds to one of the one or more cryptocurrency icons. The selection of the cryptocurrency may be received via a touchscreen on the electronic device or otherwise.

The method 600 further includes communicating 610, by the cryptocurrency payment wallet on the electronic device, the transaction information to a cryptocurrency payment provider for the selected cryptocurrency. The cryptocurrency payment provider corresponds to the selected cryptocurrency of the one of the one or more cryptocurrency icons.

According to an example, the method 600 may further include the optional step of rendering 603, on the display of the electronic device, one or more cryptocurrency payment wallet icons. The cryptocurrency payment wallet is executed based on a wallet selection input received by the electronic device. The wallet selection input corresponds to one of the one or more cryptocurrency payment wallet icons.

According to an example, the method 600 may further include the optional step of displaying 607, by the electronic device, the transaction information.

According to an example, the method 600 may further include the optional step of receiving 611, by the electronic device, a payment confirmation from the cryptocurrency payment provider. The method 600 may further include the optional step of displaying 612, by the electronic device, the payment confirmation. The payment confirmation may be displayed by the cryptocurrency payment wallet on the electronic device 200.

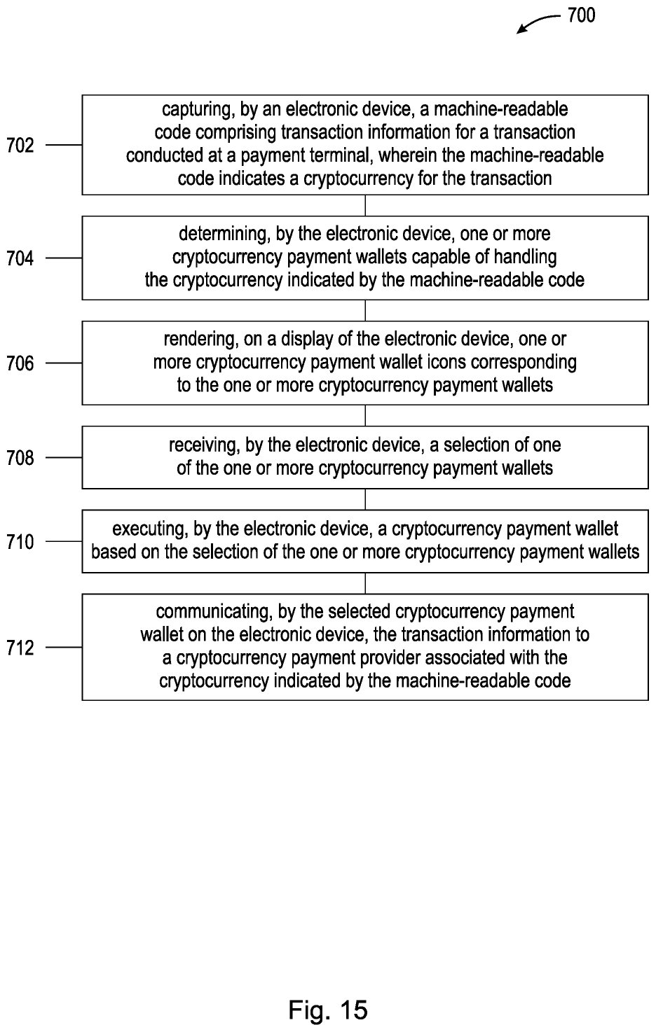

FIG. 15 is a flowchart of a further example method 700 for processing cryptocurrency payments. The method 700 includes capturing 702, by an electronic device, a machine-readable code. The machine-readable code includes transaction information for a transaction conducted at a payment terminal. The machine-readable code indicates a cryptocurrency.

The method 700 further includes determining 704, by the electronic device, one or more cryptocurrency payment wallets capable of handling the cryptocurrency indicated by the machine-readable code.

The method 700 further includes rendering 706, on a display of the electronic device, one or more cryptocurrency payment wallet icons corresponding to the one or more cryptocurrency payment wallets determined to be capable of handling the cryptocurrency indicated by the machine-readable code for the transaction.

The method 700 further includes receiving 708, by the electronic device, a selection of one of the one or more cryptocurrency payment wallets.

The method 700 further includes executing 710, by the electronic device, a cryptocurrency payment wallet based on the selection of the one of the one or more cryptocurrency payment wallet.

The method 700 further includes communicating 712, by the executed cryptocurrency payment wallet on the electronic device, the transaction information to a cryptocurrency payment provider associated with the cryptocurrency indicated by the machine-readable code.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method for cryptocurrency payments, comprising:
displaying, by a display on a payment terminal, one or more cryptocurrency payment wallet icons;
receiving, by the payment terminal, a selection of a cryptocurrency payment wallet for conducting a transaction, wherein the selection corresponds to one of the one or more cryptocurrency payment wallet icons;
generating, by the payment terminal, a machine-readable code for the selection of the cryptocurrency payment wallet, wherein the machine-readable code comprises transaction information;
displaying, by the display on the payment terminal, the machine-readable code;
receiving, by the payment terminal, a payment confirmation from a cryptocurrency payment provider associated with a cryptocurrency selected from the cryptocurrency payment wallet; and
displaying, by the display on the payment terminal, the payment confirmation.

2. The method of claim 1, wherein the display on the payment terminal is a touchscreen, and wherein the selection of the cryptocurrency payment wallet is received via the touchscreen.

3. The method of claim 1, wherein the selection of the cryptocurrency payment wallet is received via a keypad on the payment terminal.

4. The method of claim 1, wherein the machine-readable code is a quick response (QR) code.

5. The method of claim 1, wherein the transaction information comprises a payment total, a merchant identifier, a payment terminal identifier, product information, and/or service information.

6. The method of claim 5, wherein the machine-readable code is displayed with the payment total, and wherein the payment confirmation is displayed as a government-issued currency payment total and/or a cryptocurrency payment total.

7. The method of claim 1, wherein the selection of the cryptocurrency payment wallet corresponds to one of the one or more cryptocurrency payment wallet icons.

8. The method of claim 1, wherein the payment terminal is configured to display one or more cryptocurrency icons, and wherein the cryptocurrency payment provider corresponds to one of the one or more cryptocurrency icons.

9. A method for cryptocurrency payments, comprising:
capturing, by an electronic device, a machine-readable code comprising transaction information for a transaction conducted at a payment terminal;
executing, by the electronic device, a cryptocurrency payment wallet upon capturing the machine-readable code;
rendering, on a display of the electronic device, one or more cryptocurrency icons;
receiving, by the cryptocurrency payment wallet on the electronic device, a selection of a cryptocurrency for the transaction, wherein the selection corresponds to one of the one or more cryptocurrency icons; and
communicating, by the cryptocurrency payment wallet on the electronic device, the transaction information to a cryptocurrency payment provider for the selected cryptocurrency, wherein the cryptocurrency payment provider corresponds to the selected cryptocurrency of the one of the one or more cryptocurrency icons.

10. The method of claim 9, wherein the cryptocurrency payment wallet is executed based on the machine-readable code.

11. The method of claim 9, wherein the cryptocurrency payment wallet is executed based on a default wallet setting stored on the electronic device.

12. The method of claim 9, further comprising rendering, on the display of the electronic device, one or more cryptocurrency payment wallet icons, wherein the cryptocurrency payment wallet is executed based on a wallet selection input received by the electronic device, and wherein the wallet selection input corresponds to one of the one or more cryptocurrency payment wallet icons.

13. The method of claim 9, wherein the selection of the cryptocurrency is received via a touchscreen on the electronic device.

14. The method of claim 9, wherein the transaction information comprises a payment total, a merchant identifier, a payment terminal identifier, product information, and/or service information.

15. The method of claim 9, further comprising displaying, by the electronic device, the transaction information.

16. The method of claim 9, wherein the machine-readable code is a quick response (QR) code.

17. The method of claim 9, further comprising:
receiving, by the electronic device, a payment confirmation from the cryptocurrency payment provider; and
displaying, by the electronic device, the payment confirmation.

18. The method of claim 17, wherein the payment confirmation is displayed by the cryptocurrency payment wallet.

19. The method of claim 9, wherein the machine-readable code is captured by a camera of the electronic device.

20. A method for cryptocurrency payments, comprising:
capturing, by an electronic device, a machine-readable code comprising transaction information for a transaction conducted at a payment terminal, wherein the machine-readable code indicates a cryptocurrency for the transaction;
determining, by the electronic device, one or more cryptocurrency payment wallets capable of handling the cryptocurrency indicated by the machine-readable code;
rendering, on a display of the electronic device, one or more cryptocurrency payment wallet icons corresponding to the one or more cryptocurrency payment wallets;
receiving, by the electronic device, a selection of one of the one or more cryptocurrency payment wallets;
executing, by the electronic device, a cryptocurrency payment wallet based on the selection of the one or more cryptocurrency payment wallets; and
communicating, by the executed cryptocurrency payment wallet on the electronic device, the transaction information to a cryptocurrency payment provider associated with the cryptocurrency indicated by the machine-readable code.
